(19) United States
(12) Patent Application Publication
(10) Pub. No.: US 2025/0217803 A1
(43) Pub. Date: Jul. 3, 2025

(54) COMMUNICATION SYSTEM, METHOD AND COMPUTER PROGRAM

(71) Applicant: nChain Licensing AG, Zug (CH)

(72) Inventors: Alessio PAGANI, London (GB); Craig WRIGHT, London (GB)

(21) Appl. No.: 18/850,534

(22) PCT Filed: Mar. 2, 2023
(86) PCT No.: PCT/EP2023/055309

§ 371 Date: Sep. 24, 2024

(30) Foreign Application Priority Data
Mar. 31, 2022 (GB) 2204649.4

(51) Int. Cl. G06Q 20/40; G06Q 20/38

(52) U.S. Cl. CPC G06Q 20/401; G06Q 20/3825; G06Q 20/3829

(57) ABSTRACT

A computer-implemented method, the method performed by a controller configured to communicate with a blockchain and with a network comprising one or more devices, the method comprising: maintaining identification information comprising an index number assigned to each of the one or more devices; receiving one or more input-output pairs of a blockchain transaction, wherein each input-output pair is associated with an assigned index number and wherein each input-output pair comprises data from a device of the one or more devices; generating a blockchain transaction based on the one or more input-output pairs; sending the blockchain transaction to the blockchain.

### CROSS REFERENCE TO RELATED APPLICATIONS

This application is the U.S. National Stage of International Application No. PCT/EP2023/055309 filed on Mar. 2, 2023, which claims the benefit of United Kingdom Patent Application No. 2204649.4, filed on Mar. 31, 2022, the contents of which are incorporated herein by reference in their entireties.

### TECHNICAL FIELD

The present disclosure relates to a system, method and computer program for communication. Some embodiments relate to a communication protocol that stores information on a blockchain.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY

Examples described herein provide a low-power protocol for enabling communications between devices (e.g., Internet of Thing (IoT) devices) and the blockchain using ad-hoc local networks. In some examples, a controller may manage a network of devices. The devices can communicate locally, and also can communicate externally to the network. External communications may be stored on the blockchain.

According to one aspect disclosed herein, there is provided a computer-implemented method, the method performed by a controller configured to communicate with a blockchain and with a network comprising one or more devices. The method may comprise maintaining identification information comprising an index number assigned to each of the one or more devices and receiving one or more input-output pairs of a blockchain transaction, wherein each input-output pair is associated with an assigned index number and wherein each input-output pair comprises data from a device of the one or more devices, the data signed by a signature corresponding to a public key of the device. The method may further comprise generating a blockchain transaction based on the one or more input-output pairs and sending the blockchain transaction to the blockchain.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3A is a schematic block diagram of a client application,

FIG. 3B is a schematic mock-up of an example user interface that may be presented by the client application of FIG. 3A,

FIG. 4 is a schematic block diagram of some node software for processing transactions,

FIG. 5 is a schematic diagram showing different layers of a communication protocol,

FIG. 6 is a schematic block diagram of a network,

FIG. 7 is a schematic block diagram showing an example of a controller operating in a first mode,

FIG. 8 is a schematic block diagram showing an example of a controller operating in a second mode.

### DETAILED DESCRIPTION OF EMBODIMENTS

### Example System Overview

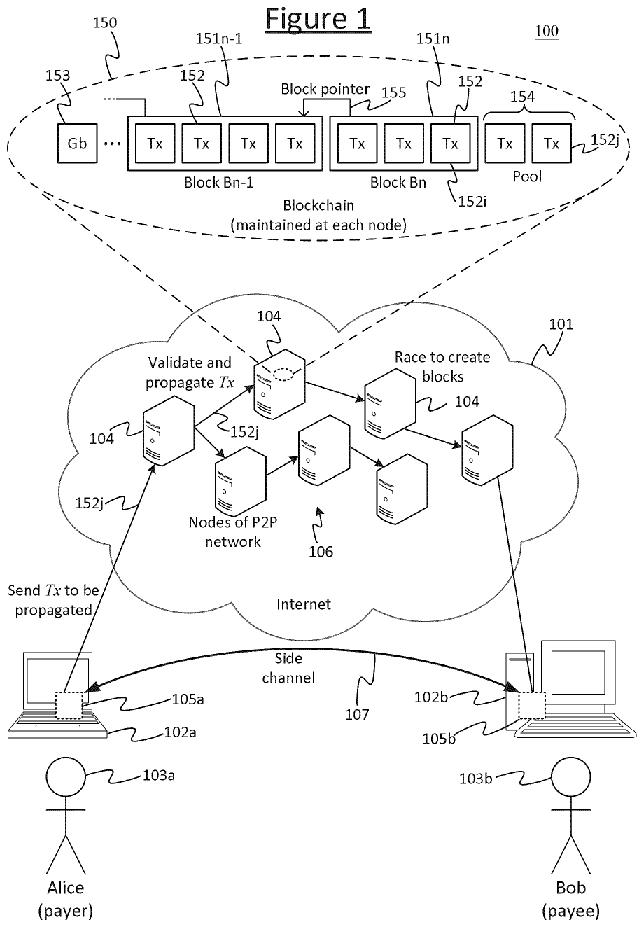

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction spends (or “assigns”), wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (or “spent”) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n−1 in the chain. The significant amount of effort, for example in the form of hash, required to create a proof-of-work solution signals the intent of the first node 104 to follow the rules of the blockchain protocol. Such rules include not accepting a transaction as valid if it spends or assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee” and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### UTXO-Based Model

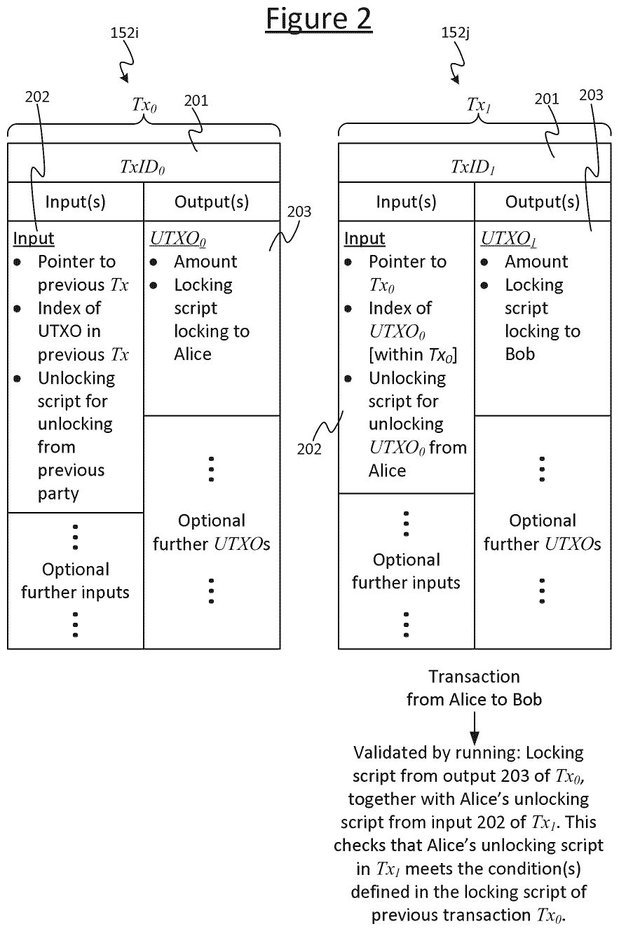

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:
<Sig P_{A}><P_{A}>∥[Checksig P_{A}]
where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned (or spent) by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### Client Software

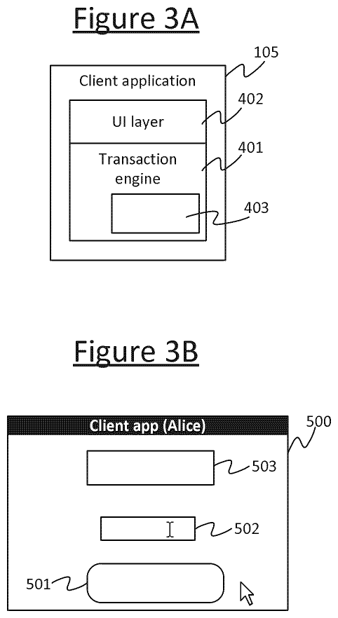

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the schemes discussed above and as discussed in further detail shortly. In accordance with embodiments disclosed herein, the transaction engine 401 of each client 105 may comprise a function 403.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands).

Alternatively or additionally, the UI elements may comprise one or more data entry fields 502, through which the user can . . . . These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 503 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3 is only a schematized mock-up and in practice it may comprise one or more further UI elements, which for conciseness are not illustrated.

### Node Software

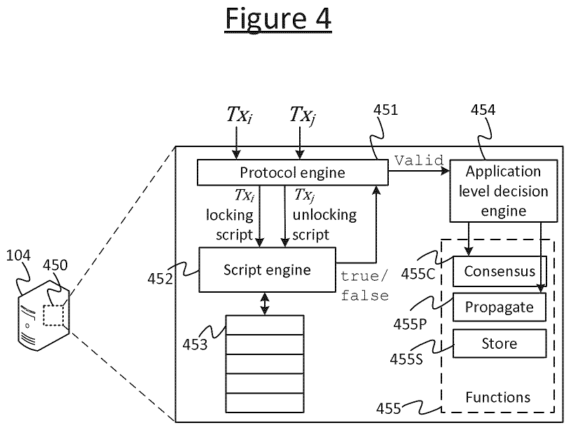

FIG. 4 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Tx and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

### Communication System, Method and Computer Program

Networks can be used to communicate and manage one or more devices. Each network may have a corresponding controller. In some examples, the devices (non-controller devices) in the network may comprise devices that operate using a low amount of energy. Such devices may be termed Low-Power Electronics (LPE). In the following, a device in a local network controlled by a controller may be referred to as an “LPE”, however it will be understood that one or more of the LPE devices may be replaced with other devices that are not LPE devices. LPE devices may comprise, for example, an Internet of Thing (IoT) device such as an IoT sensor. It should be noted that while some examples are applicable to systems comprising LPE devices, the methods and systems disclosed herein are also applicable to other types of devices.

In examples, a local network comprising a controller and one or more devices is created and managed by the controller. The network is enabled to partake in internal communication and external communication through blockchain transactions. Transactions in the network may be certified using the blockchain.

As LPE devices such as IoT devices are more commonly used, communication protocols adapted to the efficiency needs of LPE devices are required. These communication protocols can also be used with other types of devices to improve efficiency of operation. Some examples disclosed herein also maintain data integrity of some forms of communication within the system. Some examples disclosed herein also provide a system capable of certification of communications within a system.

Some examples describe a blockchain-based communication protocol. The blockchain-based communication protocol may comprise a Bitcoin-based communication protocol. The blockchain-based communication protocol can allow low-bandwidth and/or low-energy communication while natively embedding blockchain-based specific capabilities as an underlying service for notarisation, data integrity and certification.

Some examples may provide a communication protocol within a system that communicates internally at a certain network layer. External communication to the system (incoming or outgoing) may be certified as a transaction on the blockchain.

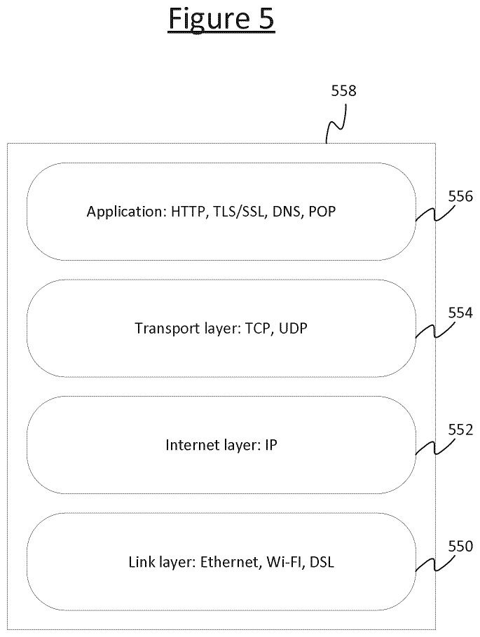

An example of network layers is shown in FIG. 5. In the example of FIG. 5, the Internet Protocol Suite (Transport Control Protocol/Internet Protocol (TCP/IP)) is shown, but it will be understood that the method disclosed herein could be applied to other network configurations.

The Internet Protocol suite (TCP/IP) defines a set of protocols used for communication in computer networks. The Internet Protocol suite (TCP/IP) is conceptually structured in a system 558 comprising four layers which describe, at different granularity, how data is transmitted. A first layer 550 comprises a Link layer. Link layer 550 may be used for Ethernet, Wi-fi or Digital Subscriber Line (DSL) communications.

Above the Link layer 550 there is provided an Internet layer 552 which can be used, for example, for Internet Protocol communications. Above Internet layer 552 there is provided a transport layer 554. Transport layer 554 can be used for Transmission Control Protocol (TCP) and User Datagram Protocol (UDP) communications. Application layer 556 may be used for at least one of: Hypertext Transfer Protocol (HTTP) communications; Transport Layer Security (TLS)/Secure Sockets Layer (SSL) communications; Domain Name System (DNS) communications; Point of Presence (POP) communications.

Internet layer 552 defines how devices identify and locate themselves in a network. Internet layer 552 includes methods, protocols, and specifications that are used to address and transport packets across a network and among different network. The core of the Internet layer 552 is the IP protocol, widely used to specify the packet destination and for routing purposes.

Some of the examples disclosed herein define a Peer-to-Peer (P2P) protocol that may be employed at the same level as Internet layer 552, enabling communication of low power devices (e.g., IoT devices) within a network and with the blockchain. The protocols disclosed herein may be applied to system of any type of devices, but are useful for LPE devices such as IoT devices that are generally very small low-power tools not connected to a power supply. Due to their limited amount of available energy, LPE devices need efficient hardware and low-rate, low-energy communication protocols. A protocol disclosed herein enables communication between devices and the blockchain using local networks. The local networks may comprise ad-hoc local networks.

In a specific example, the protocol may be referred to as “P2P Bitcoin Internet Layer Protocol” or BILP. However, it should be noted that the protocol is not limited to the use of Bitcoin (other blockchains may be used) and is not limited to the Internet Layer (it may operate in different layers of a communication network).

A system 600 comprises a controller apparatus 660. One or more devices 662a, 662b and 662c can communicate with an external network via controller 660. At least one of the one or more devices 662a, 662b and 662c may comprise an LPE. A local network 690 may comprise controller 660 and the one or more devices 662a, 662b and 662c. Controller 660 can be used to manage network 690 and coordinate the one or more devices 662a, 662b and 662c. Although three devices 662a, 662b and 662c are shown in system 600, network 690 may comprise more or fewer devices.

Controller 690 and the one or more devices 662a. 662b and 662c may communicate within the local network 690 within a certain network layer. For example, the communication within local network 690 may occur at the Internet layer.

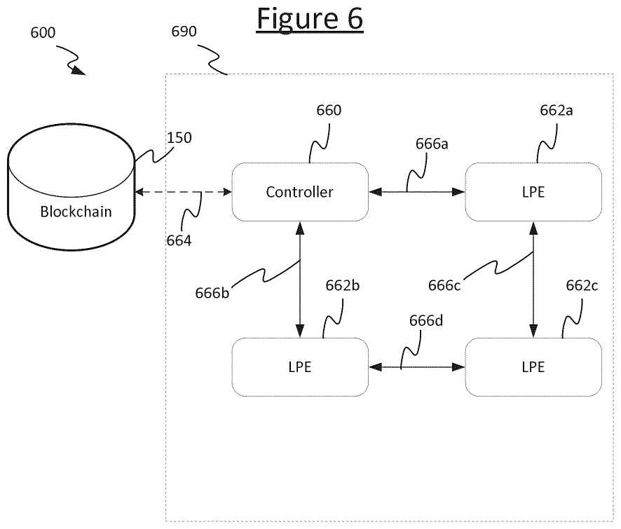

In the example of FIG. 6, controller 690 may communicate with device 662a over connection 666a. Controller 690 may also communicate with device 662b over connection 666b. Device 662b may communicate with device 662c over connection 666d. Device 662c may communicate with device 662a over connection 666c.

Controller 660 may communicate with devices external to network 690. Controller may communicate with the blockchain 150 (which may be a blockchain node or the blockchain network) over connection 664. In some examples, connection 664 comprises a TCP/IP connection. In some examples, connections 666a, 666b and 666c comprise low-power connections. As an example, a low-power connection may comprise, for example, a Bluetooth Low Energy connection.

Controller 660 may collate messages from devices 662a, 662b and 662c into blockchain transactions (e.g., Bitcoin transactions) and send the blockchain transaction to the blockchain 150. By exchanging information structured within blockchain transactions, devices 662a, 662b, and 662c can communicate among themselves (exchange updates and pass messages on), communicate with external resources and upload/retrieve data to/from the blockchain 150. The communication protocol can therefore provide native data integrity and certification with low-bandwidth, low-energy communication.

In some examples, the only device in system 690 connected to the internet is controller 690, and devices 662a, 662b and 662c communicate with the controller or with each other via low-power connections.

In some examples, network 690 comprises a local network. In some examples, network 690 comprises an ad-hoc network. A network 690 that follows the BILP rules may be considered to comprise a “BILP network”.

Controller 660 may be the most capable device in network 690. Controller 660 may act as a coordinator for the other devices 662a, 662b and 662c. Controller 660 may be the only device in network 660 that interacts with the blockchain 150. In some examples, controller 660 may comprise a wired device with enough power and bandwidth to maintain a stable connection with the blockchain, and to receive and broadcast blockchain transactions. In some examples, controller 660 may manage the other devices in network 690. In some examples, controller 660 may collect and route transactions from/to devices 662a, 662b, and 662c.

Devices 662a, 662b, and 662c may comprise LPE devices such as IoT sensors. Such devices may be designed to sacrifice some performance in exchange for low energy consumption and long battery life. Such devices are usually wireless IoT devices that communicate at low-power, low-frequency with a central coordinator (which may be controller 690). To increase the network robustness and resilience, in some implementations devices 662a, 662b and/or 662c can also broadcast messages coming from other devices (e.g., other LPEs) to controller 690 and vice-versa, creating a mesh network 690.

In BILP, the power requirement for the one or more devices 662a, 662b or 662c is low. Apart from the energy/computation required to accomplish the task it is designed for (e.g., measure temperature, record some actions), the devices 662a, 662b and 662c only require enough computational power to create and sign a raw transaction and transmit it to controller 660.

Devices 662a, 662b and 662c may uniquely identify themselves using an identifier, for example a public key. For simplicity and compatibility, a public key in some examples may be derived from a private key following the same rules used to generate public keys for blockchain (e.g., Bitcoin) transactions. Data from devices 662a, 662b and 662c transmitted inside and outside of network 690 can be signed using the corresponding private key of device 662a, 662b or 662c to create an immutable association between the data from a device and the device that published it. For example, it is always possible to trace which device published some given information, or to retrieve all the information published by a single device. As the private key is embedded in the device, the signature can also be used as a form of certification.

Networks described herein (including BILP networks) can be divided into two classes, depending on who funds the transactions containing the message and data to be published on the blockchain 150. In a first class, “controller pays for all”, controller 660 acts as a master peer, broadcasting the messages to the blockchain and funding the transactions for the entire BILP network. This approach can be chosen when LPE devices 662a, 662b and 662c are trusted and managed by controller 660 (e.g., a set of IoT sensors in a building). In a second class, “LPE pay for itself”, controller 660 acts as a coordinator and gateway to the blockchain 150 but each LPE 662a, 662b and 662c is responsible for funding the information they want to share and publish. This approach should be chosen when the LPE devices 662a, 662b and 662c are independent entities and may connect temporarily to a BILP network 690 (e.g., an electric car connecting to a vehicle charging station).

BILP networks such as network 690 can be used in system-to-system exchanges and in IoT groups where a transaction is signed by multiple parties and collated by a gateway to be sent to the blockchain 150. Controller 660 may be connected to the blockchain 150. In some examples, controller 660 may be connected to the blockchain 150 through a mAPI gateway as discussed in “Merchant API documentation” github.com/bitcoin-sv-specs/brfc-merchantapi using a standard internet connection (i.e., IP protocol). In this way, controller 660 may acts as a gateway and transaction broadcaster to/from the blockchain and the LPEs 662a, 662b and 662c.

Communications 666a, 666b and 666c between LPEs 662a, 662b and 662c within the same BILP network 690 may comprise P2P or peer-to controller connections that follow BILP. For specific cases, for example when the transactions have an implicit hierarchy or require an access control, some of the BILP transactions can be structured using the Metanet protocol [BSV wiki, “Metanet Protocol”, wiki.bitcoinsv.io/index.php/Metanet_Protocol].

Devices such as LPEs 662a, 662b and 662c belonging to the same network 690 may be identified using a unique ID. Each LPE 662a, 662b and 662c communicates its ID to the interested parties (including controller 660). The ID of a device can be a public key of the respective device's choice (generated from a private key they control) or, alternatively, a hash derived from the unique LPE hardware and software. In the following, without loss of generality, the LPEs 662a, 662b and 662c are identified in the local network using a public key, but it will be understood that hashes or any other forms of identification can be used. Controller 660 maintains identification information of the LPEs 662a, 662b and 662c. The identification information may comprise a list of IDs, called ID table, comprising all the identifiers (e.g., public keys) of the connected LPEs 662a, 662b and 662c.

The identification information stored at controller 660 may comprise a list of the identifiers (ID table) of the connected LPEs 662a, 662b and 662c. LPEs may be removed from the ID table if they actively communicate that they are leaving the network 690 or if they stop replying to controller 660 messages for too long a period of time (above a predetermined time threshold).

Three modules can be used for the communication protocol disclosed herein. An outbound communication module and an inbound communication module can be used for external devices and a local communication module may be used within the local network 690. The three modules comprise:
Outbound communication: Devices 662a, 662b and 662c (e.g., LPEs) want to transmit messages to other devices or applications outside network 690 (e.g., upload data to the blockchain).
Inbound communication: Devices 662a, 662b and 662c (e.g., LPEs) want to receive messages from other devices or applications outside network 690 (e.g., download data from the blockchain).
Local communication: Devices 662a, 662b and 662c (e.g., LPEs) want to communicate with other devices 662a, 662b and 662c within the same network 690.

A message may comprise any type of information transmitted from/to a device 662a, 662b, 662c (e.g., to an LPE device). This includes communication messages, plain or encrypted data, and any other type of information. The information can be just data (like other protocols in an Internet layer), as received from the upper layer in the Internet Protocol Suite (e.g., from TCP or UDP). Alternatively, it can be application-level information (e.g., communication messages). In the latter case, the BILP is considered a protocol that ranges from the Internet to the Application layer of the Internet Protocol Suite.

Communication among multiple BILP networks generally occur through the blockchain for auditability reasons (Outbound and Inbound communication protocol). In specific circumstances, for example when higher privacy is needed, two or more BILP networks can be connected (e.g., via VPN) through their respective controllers. In this case the communication is not stored on-chain, but instead it follows the Local communication protocol, with the controllers gathering and broadcasting message transactions among the networks.

Depending on network configuration, a controller such as controller 690 may operate in two modes (as a router or as a peer).

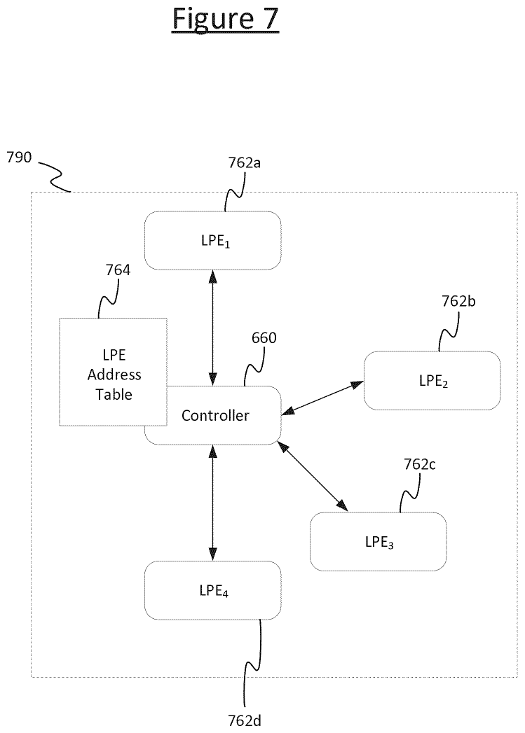

A first mode, “Router mode” is shown in FIG. 7. If controller 660 is in Router mode, in addition to the ID table, controller 660 keeps track of all the connected LPEs 762a, 762b, 762c and 762d in the local network 790 and also stores information on how to individually contact each LPE device. This additional information is stored in a separate table, called LPE address table 764. Controller 660 transmits the messages only to the indicated LPEs, using the LPE address table 764 to locate them. The router acts as a central communication point. Router mode may be preferred in some examples for networks that have a star topology. In Router mode, all the devices are connected to controller 660 that maintains a table of addresses 764 and sends direct messages to the intended recipient. The LPE address table may be considered to comprised address information comprising addresses of each of the one or more devices 762a, 762b, 762c and 762d in network 790. In router mode, sending, by the controller 660, a message to at least one of the one or more devices may comprise transmitting the at least one message directly to at least one of the one or more devices 762a, 762b, 762c and 762d in network 790 based on the address information. The controller 660 shown in FIGS. 6, 7 and 8 could be the same controller operating in different modes or network configurations. In some examples however, a different controller may be used in each mode or network configuration. Further, although the LPEs shown in each of FIGS. 6, 7 and 8 are labelled with different reference numerals, there may be some overlap between the LPE devices shown in the figures. For example, LPE device 662a may comprise LPE device 762a. In a further example, LPE device 762a may comprise LPE device 862a.

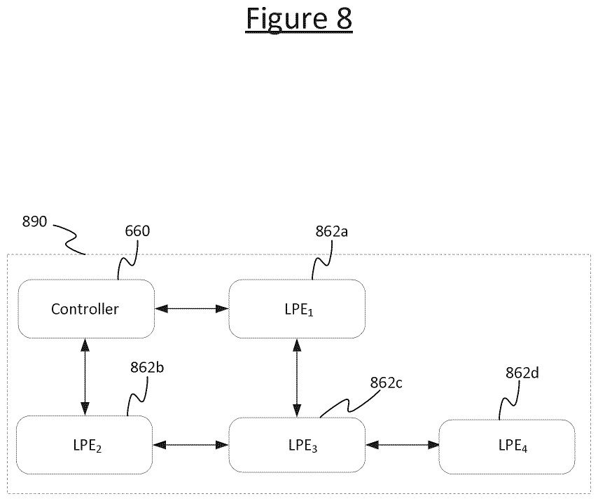

A second mode, “Peer mode” is shown in FIG. 8. If controller 660 is in Peer mode, controller 660 is not required to keep track of LPEs 862a, 862b, 862c and 862d in the local network 890 (i.e., it is not necessary to store an LPE address table and only the ID table is maintained). Messages are broadcast to the neighbours of the controller 660, which in turn broadcast them to their neighbours until the messages reach all the peers. A device may be considered to neighbour another device in the network if the devices have a direct connection to. The interested peers recognise (and optionally decrypt) the messages addressed to them. This configuration allows the creation of redundant interconnections between peers. Peer mode may be preferred for networks that have a mesh topology. In Peer mode, devices can be connected to the Controller or to another device, and messages are broadcast to all the peers until the reach the recipient. In peer mode, sending a message to at least one of the one or more devices 862a, 862b, 862c and 862d in network 890 may composite broadcasting, by controller 660, the at least one message to one or more neighbouring devices in the network, wherein the one or more neighbouring devices broadcast the at least one message to one or more further neighbouring devices until the at least one message is delivered to the at least one of the one or more devices.

When in Peer mode, communication relies on LPEs broadcasting messages to their neighbours. However, LPEs might want to be as efficient as possible, and may not propagate them in some examples. In some implementations, message propagation could be enforced, for example by blacklisting LPEs that do not broadcast messages. This can be achieved by controller 660 actively monitoring the network and removing the identifier (e.g., public key) of dishonest LPEs from the ID table (i.e., outbound communication is disabled for these LPEs).

In some examples, for additional security, messages can be encrypted using the public key of the receiver (or intended recipient). This way, only the intended receiver can decrypt a message using the corresponding private key. In some examples, an encryption scheme can be used to provide data validity, so LPEs know data has not been changed after being submitted to the blockchain or, similarly, when received from an external transmitter to an LPE.

The outbound communication module can be used for communication to external devices (e.g., devices external to network 690 in FIG. 6). Data can be stored/certified on-chain using the outbound communication module. An upload from a BILP local network to the blockchain can use coordination between the LPEs and controller 660 of the network. Fund management can be used to pay the correct amount of fees when publishing the blockchain transaction on-chain.

The outbound communication module can be managed through communication rounds (BILP communication rounds). Controller 660 can maintain identification information for each device 662a, 662b and 662c in network 690. The identification information may comprise an index number assigned to each device. Each communication round can be initiated by controller 660. Controller 660 assigns an index number to each device in the network. This may be performed using the ID table. The index number for a specific device may be communicated from the controller 660 to the respective specific device. The index number indicates an outpoint index reserved for a specific device. Each device (e.g., LPE device) identifier (e.g., public key) may be mapped to an outpoint. Each device may then create a blockchain partial transaction (e.g. an input-output pair) where it inserts the data it wants to broadcast, using the index number that was assigned to it. The data may be signed using a private key of the device. The data may include measurements (e.g., sensor measurements) made by the device. The data may be inserted using an OP_RETURN function, or using OP_PUSH and OP_DROP functions, for example. The partial transaction (input-output pair) generated by each LPE is then broadcast to the connected LPEs which in turn re-broadcast to their neighbours. If an LPE has multiple connections it might receive the same partial transaction multiple times, in this case all the duplicated messages can be safely discarded.

When a new communication round starts, devices (e.g., LPEs) can create blockchain (e.g., Bitcoin) transactions with the flag SIGHASH_SINGLE|ANYONECANPAY, filling the input and output corresponding to the index that has been assigned from controller 660. This partial transaction is transmitted to controller 660.

TABLE 1
Example of a partial transaction (input-output pair) created by LPE i,
where index i is assigned by the Controller for a specific communication
round. Fields surrounded by asterisks (*) may be signed
when SIGHASH_SINGLE / ANYONECANPAY is active.
TxIDₓ

| | | | |
|---|---|---|---|
| Version | *1* | Locktime | *0* |
| In-count | . . . | Out- | . . . |
| | | count | |

| Input list | | | Output list | |
|---|---|---|---|---|
| Outpoint | Unlocking script | Seq. Num. | Value | Locking script |
| TxIDₒ\|\|0 | . . . | | . . . | . . . |
| *TxID_{LPEi}\|\|0* | < Sig_{LPEi} > | *i* | *0* | *OP_RETURN < data_{LPEi} >* |
| | < PK_{LPEi} > | | | |
| TxIDₙ\|\|0 | . . . | | . . . | . . . |

At the end of each communication round, the partial transactions can be collated by controller 660 in a new transaction (a “BILP transaction”) to be published on-chain.

BILP transactions are data structures that use a blockchain (e.g., Bitcoin) transaction protocol to broadcast information within the network and, through controller 660, publish them to the blockchain 150. Each transaction contains an input/output pair for each LPE connected to the network (according to the assigned outpoint index) and a signature from controller 660.

When a communication round starts, devices (e.g., LPEs) can create their own partial transactions or append their input and output to an existing partial transaction (if they already received at least one). In both cases, devices fill only the input/output pair with the index assigned by controller 660 so the single transactions can be checked and merged by controller 660 in the finalised BILP transaction. Depending on the network type, the outpoint TxID_{LPEi} can be a simple dust transaction used to sign and certify the data (“Controller pays for all” type) or it can contain enough value (e.g., satoshis) to fund the transaction (“LPE pays for itself” type). Note that devices do not have a change address and in the latter approach any additional fund is collected by controller 660. In both cases, each device may use a preloaded list of UTXOs to be consumed over time.

In some implementations, the communication round can be preceded by an acknowledgement round, where only devices willing to communicate express their intention to do so. In this case, only devices that expressed their interest will be assigned an outpoint index by controller 660 in the next BILP transaction. Devices can skip some rounds to gain additional energy efficiency at the expense of output frequency. Prior to receiving the one or more input-output pairs from the one or more devices in network 690 for generating the blockchain transaction by controller 660, controller 660 may send a request to each of the one or more devices to confirm an intention to participate in a round of communication. In response to the request, controller 660 may receive an indication of the intention to participate in the round of communication from at least one of the one or more devices.

Once all intending devices broadcast their partial transactions, controller 660 may generate a blockchain transaction based on the one or more input-output pairs received from the devices. This may be performed by collating the input-output pairs to the same transaction by controller 660. Prior to sending the blockchain transaction to the blockchain, controller 660 may add an additional outpoint to the blockchain transaction, the additional outpoint indicating that the controller has signed all of the inputs and all of the outputs of the blockchain transaction. For example, controller 660 may add an additional outpoint with the SIGHASH_ALL flag to certify the transaction and make it immutable. If the network is “Controller pays for all”, controller 660 outpoint may also include the required amount (e.g., satoshis) to fund all the other outpoints in the transaction and may also add the related controller 660 change output (See table 1). Finally, controller 660 broadcasts the finalised BILP transaction to the blockchain (i.e., to the blockchain 150) certifying the data and the messages.

TABLE 2
Example of BILP finalised transaction created by the Controller. Fields
surrounded by asterisks (*) may be signed when SIGHASH_ALL is active.
TxIDₓ

| | | | |
|---|---|---|---|
| Version | *1* | Locktime | *0* |
| In-count | n + 1 | Out- | n + 1 |
| | | count | |

| Input list | | | | |
|---|---|---|---|---|
| | | Seq. | Output list | |
| Outpoint | Unlocking script | Num. | Value | Locking script |
| *TxID_{LPE0}\|\|0* | < Sig_{LPE0} > | *0* | *0* | *OP_RETURN < |
| | < PK_{LPE0} > | | | data_{LPE0} >* |
| *. . .* | . . . | *. . .* | *. . .* | *. . .* |
| *TxID_{LPEn}\|\|0* | < Sig_{LPEn} > | *n* | *0* | *OP_RETURN < |
| | < PK_{LPEn} > | | | data_{LPEn} >* |
| *TxID_{Controller}\|\|0* | < Sig_{Controller} > | *n + 1* | *change* | *P2PKH <Controller |
| | < PK_{Controller} > | | | change address>* |

An inbound communication module can used to download data from the blockchain to the local (BILP) network. The inbound communication module may also be used retrieving external messages.

In some examples, to maintain compatibility with the other modules, the inbound module can follow the same rules and structure of the outbound module. Controller 660 retrieves the messages from the blockchain and transmits them to the interested devices according to the configured Controller type (Router or Peer mode as discussed above).
Router mode: Controller 660 transmits the message to the indicated LPE (according to the public key or other identifier). The interested device decrypts the message.
Peer mode: Controller 660 broadcasts the message to its neighbours, which in turn broadcast to their neighbours until the message reaches all the peers. The interested peer recognises and decrypts the message.

An example of a transaction retrieved from the blockchain and transmitted to 3 LPEs is shown in Table 3.

TABLE 3
Example of BILP inbound transaction. In the example three LPEs,
namely LPE_{alice}, LPE_{bob}, and LPE_{charlie}, received a message
from a transmitter located outside the BILP network. Data can be
encrypted using the receiver's public key to enhance privacy.
TxIDₓ

| | | | |
|---|---|---|---|
| Version | 1 | Locktime | 0 |
| In-count | 2 | Out- | 3 |
| | | count | |

| Input list | | | | |
|---|---|---|---|---|
| | | Seq. | Output list | |
| Outpoint | Unlocking script | Num. | Value | Locking script |
| TxIDₜᵣₐₙₛₘᵢₜₜₑₑᵣ\|\|0 | < Sigₜᵣₐₙₛₘᵢₜₜₑᵣ > | 0 | 0 | OP_RETURN to: <PK_{LPEbob}> |
| | < PKₜᵣₐₙₛₘᵢₜₜₑᵣ > | | | message: < data > |
| | | | 0 | OP_RETURN to: <PK_{LPEbob}> |
| | | | | message: < data > |
| | | | 0 | OP_RETURN to: <PK_{LPEcharlie}> |
| | | | | message: < data > |

Controller 660 can identify transactions intended for its internal (BILP) network by monitoring the blockchain for a transaction identifying (comprising) the identifier(s) (e.g., public key(s)) of at least one of the one or more devices 662a, 662b and 662c in network 690 or by using other techniques available (e.g., the external transmitter can notify them to controller 660, the notification comprising a public key or other identifier of at least one of the one or more devices 662a, 662b and 662c). Controller 660 may identify a transaction on the blockchain comprising at least one message intended for at least one of the one or more devices in the network, and then retrieve the at least one message from the blockchain and send the at least one message to the at least one of the one or more devices 662a, 662b and 662c in network 690. The approach used to identify inbound transactions and retrieve them is similar to other applications (e.g., wallets).

A local communication module can be used to exchange messages within the same network, these locally communicated messages are not recorded on-chain. As for the inbound module, depending on the network configuration, controller 660 can act as a router or as a peer.
Router mode: Devices always send messages to Controller 660 which transmits the message to the indicated LPE (according to the public key or other identifier). The interested peer decrypts the message.
Peer mode: Devices broadcasts messages to neighbours, which in turn broadcast to their neighbours until the message reaches all the peers. The interested peer recognises and decrypts the message.

To maintain compatibility and consistency with the other modules, local communication modules may follow the same rules and structure of the previously described modules. As in this module the transaction does not need to be finalised or broadcast externally by controller 660, there is no need to use the BILP communication round protocol (defined in the outbound module) to preassign indexes (i.e., sequence numbers). After being shared internally, the transaction can be discarded. Any LPE willing to communicate can create a Bitcoin transaction with the flag SIGHASH_SINGLE|ANYONECANPAY (Table 4). The transaction is transmitted, depending on the network configuration, to controller 660 (router mode) or to the LPE's neighbours (peer mode).

From the perspective of controller 660, when using a local communication module and operating in router mode the method may comprise receiving, from a first device in the network, a message intended for a second device in the network and transmitting the message to the second device in the network. Controller 660 may then discard the message after transmitting to the second device in the network.

From the perspective of controller 660, when using a local communication module and operating in peer mode the method may comprise receiving, from a neighbouring device in the network, a message broadcast from the neighbouring device, the message intended for a third device in the network and broadcasting the message to one or more neighbouring devices in the network. Controller 660 may then discard the message after transmitting to the one or more neighbouring devices in the network.

Note that these transactions are for internal communication only (they are not published on-chain), for this reason they do not need to be funded (e.g., a spent transaction output can be reused). They maintain the blockchain transaction structure just for compatibility with the other communication modules. As for the other communications, for additional security, messages can be encrypted using the public key of the receiver.

TABLE 4
Example of a (BILP) partial transaction used for local
communication. In the example LPE_{alice} is transmitting
some data to LPE_{bob} using his public key.
TxIDₓ

| | | | |
|---|---|---|---|
| Version | 1 | Locktime | 0 |
| In-count | 1 | Out- | 1 |
| | | count | |

| Input list | | | | |
|---|---|---|---|---|
| | | Seq. | Output list | |
| Outpoint | Unlocking script | Num. | Value | Locking script |
| TxID_{LPEalice}\|\|0 | < Sig_{LPEalice} > | 0 | 0 | OP_RETURN to: <PK_{LPEbob}> |
| | < PK_{LPEalice} > | | | message: < data > |

For some use-cases it may be useful to maintain and prove the order in which the messages were transmitted (e.g., an internal communication where two devices exchange data). In this case, messages can be grouped in threads. Threads do not require any additional logic; they are just agreed between two or more devices. If a message is part of a thread of messages, other LPEs can append their messages to the same transaction (as SIGHASH_SINGLE|ANYONECANPAY is used). Using the sequence number, the order in which the messages are created is recorded in the transaction. This allows the creation of ordered sequences of messages for internal communication. As the internal communication is entirely off-chain, ordering cannot be enforced, but it is rather a choice of a LPE to respond to an existing thread by appending its message to an existing transaction.

Every time a transaction is updated with new data (i.e., output pairs), the message transmission protocol (router mode or peer mode) can be re-initiated (i.e., local re-broadcast) as an updated message is equivalent to a new message.

TABLE 5
Example of a partial transaction used for local communication update.
A new input/output pair is appended to the previous communication
message. In the example LPE_{bob} is replying to LPE_{alice}.
The sequence number guarantees the transaction order.
TxIDₓ

| | | | |
|---|---|---|---|
| Version | 1 | Locktime | 0 |
| In-count | 2 | Out- | 2 |
| | | count | |

| Input list | | | | |
|---|---|---|---|---|
| | | Seq. | Output list | |
| Outpoint | Unlocking script | Num. | Value | Locking script |
| TxID_{LPEalice}\|\|0 | < Sig_{LPEalice} > | 0 | 0 | OP_RETURN to: <PK_{LPEbob}> |
| | < PK_{LPEalice} > | | | message: < data > |
| TxID_{LPEbob}\|\|0 | < Sig_{LPEbob} > | 1 | 0 | OP_RETURN to: <PK_{LPEalice}> |
| | < PK_{LPEbob} > | | | message < data > |

When using the inbound or outbound communication modules, a record for the data sent from a local network may be stored on the blockchain. When using the local communication module, a record may not be sent.

In some examples, communication within a local network is performed at the Internet layer of the Internet Protocol Suite.

The data sent by the one or more devices (LPEs) of the network may comprise at least one of: temperature; humidity; air quality; image information of zones of the environment.

The above-described protocol can be used in building management. IoT devices can communicate and share information through a BILP network. All the data and messages are automatically certified on-chain. Public information can be directly broadcast and made available to possible users, while private information can be certified by publishing only its hash digest. As an example, IoT sensors can monitor temperature and humidity of workplaces certifying the air quality, while other sensors can record access to restricted zones.

The above-described protocol can be used in vehicle charging stations. Electric cars can connect to a charging station BILP network and use it to record information such as charging time and cost. The information can be later used for analysis or billing purposes. Moreover, cars can securely receive updates or notifications from the car manufacturer or other services. In such an example, one or more parameters of an electric vehicle charging session may be recorded. For example, the parameters may comprise at least one of: charging time; cost; energy used.

### Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However, it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

Statement 1: A computer-implemented method, the method performed by a controller configured to communicate with a blockchain and with a network comprising one or more devices, the method comprising: maintaining identification information comprising an index number assigned to each of the one or more devices; receiving one or more input-output pairs of a blockchain transaction, wherein each input-output pair is associated with an assigned index number and wherein each input-output pair comprises data from a device of the one or more devices; generating a blockchain transaction based on the one or more input-output pairs; sending the blockchain transaction to the blockchain.

Statement 2: A method according to Statement 1, wherein the method comprises: assigning the index number to each device of the one or more devices by mapping an identifier of each of the one or more devices to the index number; communicating, to each device of the one or more devices, an index number assigned to the device.

Statement 3: A method according to Statement 1 or Statement 2, wherein the method comprises: prior to receiving the one or more input-output pairs of the blockchain transaction, sending a request to each of the one or more devices to confirm an intention to participate in a round of communication; in response to the request, receiving an indication of the intention to participate in the round of communication from at least one of the one or more devices.

Statement 4: A method according to any preceding Statement, wherein the data from the device of the one or more devices is signed by a signature corresponding to a public key of the device.

Statement 5: A method according to any preceding Statement, wherein the method comprises: prior to sending the blockchain transaction to the blockchain, adding an additional outpoint to the blockchain transaction, the additional outpoint indicating that the controller has signed all of the inputs and all of the outputs of the blockchain transaction.

Statement 6: A method according to Statement 5, wherein the additional outpoint comprises an amount to fund all other outpoints in the blockchain transaction.

Statement 7: A method according to any preceding Statement, wherein the method comprises: identifying a transaction on the blockchain comprising at least one message intended for at least one of the one or more devices in the network; retrieving the at least one message from the blockchain; sending the at least one message to the at least one of the one or more devices.

Statement 8: A method according to Statement 7, wherein identifying the transaction in the blockchain comprises monitoring the blockchain for a transaction identifying an identifier of at least one of the one or more devices.

Statement 9: A method according to Statement 7 or Statement 8, wherein identifying the transaction in the blockchain comprises receiving a notification from a device external to the network, the notification comprising an identifier of at least one of the one or more devices.

Statement 10. A method according to any of Statements 7 to 9, wherein the method comprises: maintaining address information comprising addresses of each of the one or more devices; and wherein sending the at least one message to the at least one of the one or more devices comprises transmitting the at least one message directly to the at least one of the one or more devices based on the address information.

Statement 11. A method according to any of Statements 7 to 9, wherein sending the at least one message to the at least one of the one or more devices comprises broadcasting, by the controller, the at least one message to one or more neighbouring devices in the network, wherein the one or more neighbouring devices broadcast the at least one message to one or more further neighbouring devices until the at least one message is delivered to the at least one of the one or more devices.

Statement 12: A method according to any preceding Statement, wherein the method comprises: receiving, from a first device in the network, a message intended for a second device in the network; transmitting the message to the second device in the network.

Statement 13: A method according to Statement 12, wherein the method comprises: discarding the message after transmitting to the second device in the network.

Statement 14: A method according to any of Statements 1 to 11, wherein the method comprises: receiving, from a neighbouring device in the network, a message broadcast from the neighbouring device, the message intended for a third device in the network broadcasting the message to one or more neighbouring devices in the network;

Statement 15: A method according to Statement 14, wherein the method comprises: discarding the message after transmitting to the one or more neighbouring devices in the network.

Statement 16: A method according to any of Statements 7 to 15, wherein at least one message is encrypted with a public key of an intended recipient device of the network.

Statement 17: A method according to any preceding Statement, wherein the index number for a device of the one or more devices is removed or assigned to a different device if at least one of the following occurs: the device communicates that the device is leaving the network; the device does not reply to messages from the controller for a predetermined period of time; the device is identified by the controller as not broadcasting message to neighbouring devices.

Statement 18: A method according to any preceding Statement, wherein the one or more devices comprise one or more Internet of Things, IoT, devices.

Statement 19: A method according to any preceding Statement, wherein: for any communication to the network from an external entity, a record is stored on the blockchain; for any communication from the network to an external entity, a record is stored on the blockchain.

Statement 20: A method according to any preceding Statement, wherein communication within the network is performed at the Internet Layer of the Internet Protocol Suite.

Statement 21: A method according to any preceding Statement, wherein the controller is connected to one or more blockchain nodes by a Transport Control Protocol/Internet Protocol, TCP/IP, connection.

Statement 22: A method according to any preceding Statement, wherein the data from a device of the two or more devices comprises measurements made by the device.

Statement 23: A method according to any preceding Statement, wherein the one or more devices of the network are used to monitor parameters of an environment, the parameters comprising at least one of: temperature; humidity; air quality; image information of zones of the environment.

Statement 24: A method according to any preceding Statement, wherein the one or more devices of the network are used to record parameters of an electric vehicle charging session, the parameters comprising at least one of: charging time; cost; energy used.

Statement 25: A method according to any preceding Statement, wherein the one or more devices comprise two or more devices, and wherein generating the blockchain transaction based on the one or more input-output pairs comprises collating the input-output pairs to generate the blockchain transaction.

Statement 26: A method performed by a system comprising one or more devices and a controller configured to communicate with a blockchain, the method comprising: maintaining, by the controller, identification information comprising an index number assigned to each of the one or more devices; generating, by each device of the one or more devices, an input-output pair of a blockchain transaction associated with the assigned index number, the input-output pair comprising data from the device; transmitting, by each device of the one or more devices, the input-output pair to the controller; collating, by the controller, the input-output pairs to generate a blockchain transaction; sending, by the controller, the blockchain transaction to the blockchain.

Statement 27: A method performed by a system comprising one or more devices and a controller configured to communicate with a blockchain, the method comprising: maintaining, by the controller, identification information comprising an index number assigned to each of the one or more devices; generating, by each device of the one or more devices, an input-output pair of a blockchain transaction associated with the assigned index number, the input-output pair comprising data from the device; transmitting, by each device of the one or more devices, the input-output pair to the controller, such that the controller receives one or more input-output pairs; generating, by the controller, a blockchain transaction based on the one or more input-output pairs; sending, by the controller, the blockchain transaction to the blockchain.

Statement 28: A method according to claim 27, wherein the one or more devices comprise two or more devices, and wherein generating the blockchain transaction based on the one or more input-output pairs comprises collating the input-output pairs to generate the blockchain transaction.

Statement 29: Computer equipment comprising: memory comprising one or more memory units; and processing apparatus comprising one or more processing units, wherein the memory stores code arranged to run on the processing apparatus, the code being configured so as when on the processing apparatus to perform the method of any of Statements 1 to 28.

Statement 30: A computer program embodied on computer-readable storage and configured as, when run on one or more processors, to perform the method of any of Statements 1 to 28.

According to another aspect disclosed herein, there may be provided a method comprising the actions of the controller.

According to another aspect disclosed herein, there may be provided a method comprising the actions of an LPE device.

According to another aspect disclosed herein, there may be provided a method comprising the actions of a system comprising the controller and one or more LPE devices.

According to another aspect disclosed herein, there may be provided a system comprising the computer equipment of the controller.

According to another aspect disclosed herein, there may be provided a system comprising the computer equipment of an LPE device.

According to another aspect disclosed herein, there may be provided a system comprising the computer equipment of a system comprising the controller and one or more LPE devices.

1. A computer-implemented method, the method performed by a controller configured to communicate with a blockchain and with a network comprising one or more devices, the method comprising:
maintaining identification information comprising an index number assigned to each of the one or more devices;
receiving one or more input-output pairs of a blockchain transaction, wherein each input-output pair is associated with an assigned index number and wherein each input-output pair comprises data from a device of the one or more devices;
generating a blockchain transaction based on the one or more input-output pairs;
sending the blockchain transaction to the blockchain.

2. The method of claim 1, wherein the method comprises:
assigning the index number to each device of the one or more devices by mapping an identifier of each of the one or more devices to the index number;
communicating, to each device of the one or more devices, an index number assigned to the device.

3. The method of claim 1, wherein the method comprises:
prior to receiving the one or more input-output pairs of the blockchain transaction, sending a request to each of the one or more devices to confirm an intention to participate in a round of communication;
in response to the request, receiving an indication of the intention to participate in the round of communication from at least one of the one or more devices.

4. The method of claim 1, wherein the data from the device of the one or more devices is signed by a signature corresponding to a public key of the device.

5. The method of claim 1, wherein the method comprises:
prior to sending the blockchain transaction to the blockchain, adding an additional outpoint to the blockchain transaction, the additional outpoint indicating that the controller has signed all of the inputs and all of the outputs of the blockchain transaction; and
wherein the additional outpoint comprises an amount to fund all other outpoints in the blockchain transaction.

6. (canceled)

7. The method of claim 1, wherein the method comprises:
identifying a transaction on the blockchain comprising at least one message intended for at least one of the one or more devices in the network;
retrieving the at least one message from the blockchain;
sending the at least one message to the at least one of the one or more devices.

8. The method of claim 5, wherein identifying the transaction in the blockchain comprises monitoring the blockchain for a transaction identifying an identifier of at least one of the one or more devices.

9. The method of claim 7, wherein identifying the transaction in the blockchain comprises receiving a notification from a device external to the network, the notification comprising an identifier of at least one of the one or more devices.

10. The method of claim 7, wherein the method comprises:
maintaining address information comprising addresses of each of the one or more devices; and
wherein sending the at least one message to the at least one of the one or more devices comprises transmitting the at least one message directly to the at least one of the one or more devices based on the address information.

11. The method of claim 7, wherein sending the at least one message to the at least one of the one or more devices comprises broadcasting, by the controller, the at least one message to one or more neighbouring devices in the network, wherein the one or more neighbouring devices broadcast the at least one message to one or more further neighbouring devices until the at least one message is delivered to the at least one of the one or more devices.

12. The method of claim 1, wherein the method comprises:
receiving, from a first device in the network, a message intended for a second device in the network;
transmitting the message to the second device in the network.

13. The method of claim 12, wherein the method comprises:
discarding the message after transmitting to the second device in the network.

14. The method of claim 1, wherein the method comprises:
receiving, from a neighbouring device in the network, a message broadcast from the neighbouring device, the message intended for a third device in the network;
broadcasting the message to one or more neighbouring devices in the network.

15. The method of claim 14, wherein the method comprises:
discarding the message after transmitting to the one or more neighbouring devices in the network.

16. (canceled)

17. The method of claim 1, wherein the index number for a device of the one or more devices is removed or assigned to a different device if at least one of the following occurs:
the device communicates that the device is leaving the network;
the device does not reply to messages from the controller for a predetermined period of time;
the device is identified by the controller as not broadcasting message to neighbouring devices.

18. The method of claim 1, wherein the one or more devices comprise one or more Internet of Things, IoT, devices.

19. The method of claim 1, wherein:
for any communication to the network from an external entity, a record is stored on the blockchain;
for any communication from the network to an external entity, a record is stored on the blockchain.

20-24. (canceled)

25. The method of claim 1, wherein the one or more devices comprise two or more devices, and wherein generating the blockchain transaction based on the one or more input-output pairs comprises collating the input-output pairs to generate the blockchain transaction.

26. A method performed by a system including one or more devices and a controller configured to communicate with a blockchain, the method comprising:
maintaining, by the controller, identification information comprising an index number assigned to each of the one or more devices;
generating, by each device of the one or more devices, an input-output pair of a blockchain transaction associated with the assigned index number, the input-output pair comprising data from the device;
transmitting, by each device of the one or more devices, the input-output pair to the controller, such that the controller receives one or more input-output pairs;
generating, by the controller, a blockchain transaction based on the one or more input-output pairs;
sending, by the controller, the blockchain transaction to the blockchain.

27. (canceled)

28. Computer equipment comprising:
memory comprising one or more memory units; and
processing apparatus comprising one or more processing units, wherein the memory stores code arranged to run on the processing apparatus, the code being configured so as when run on the processing apparatus, the processing apparatus performs a method for a controller configured to communicate with a blockchain and with a network comprising one or more devices, the method comprising:
maintaining identification information comprising an index number assigned to each of the one or more devices;
receiving one or more input-output pairs of a blockchain transaction, wherein each input-output pair is associated with an assigned index number and wherein each input-output pair comprises data from a device of the one or more devices;
generating a blockchain transaction based on the one or more input-output pairs;
sending the blockchain transaction to the blockchain.

29. (canceled)
